(19) United States
(12) Patent Application Publication
(10) Pub. No.: US 2017/0084256 A1
(43) Pub. Date: Mar. 23, 2017

(54) MUSICAL INSTRUMENT DAMPER DEVICE

(71) Applicant: Carlas Ryan Taylor, Baxley, GA (US)

(72) Inventor: Carlas Ryan Taylor, Baxley, GA (US)

(21) Appl. No.: 15/267,891

(22) Filed: Sep. 16, 2016

Related U.S. Application Data
(60) Provisional application No. 62/219,817, filed on Sep. 17, 2015.

(51) Int. Cl. G10D 13/02

(52) U.S. Cl. CPC G10D 13/022

(57) ABSTRACT

A damper device having a damper pad and one or more support members for use with a musical instrument, such as a drum, that allows damping of the different parts of the resonance wave to be applied in variable amounts.

### FIELD OF THE INVENTION

The present invention relates to a musical instrument damper device. In particular, the musical instrument damper device is suitable for percussion instruments, such as drums.

### BACKGROUND OF THE INVENTION

The resonance produced by a musical instrument can be described as the attack, decay, sustain, and release. Specifically, the attack describes the peak amplitude of the resonance wave, the decay is the decrease in amplitude from the attack level to the sustain level, and the release is the decrease in amplitude to zero from the sustain level.

This concept is particularly important with regard to percussion instruments where it is often desirable to control the resonance of the instrument. Currently, the resonance of a percussion instrument, such as a drum, is controlled by damping the attack, decay, sustain, and release of the sound. This is known as continuous damping.

However, continuous damping has the drawback of requiring that either all or none of the attack, decay, sustain, and release are damped. This may be a problem because it may be desirable to produce an undamped attack while damping the decay, sustain, and release or to produce variable and intermediate levels of damping. Accordingly, there is a need in the art for a damper device for an instrument that allows for independent and variable damping of the attack, decay, sustain, and release.

### SUMMARY OF THE INVENTION

The present invention seeks to provide a solution to the problems in the art by providing a damper device with a movable part that allows damping of the attack, decay, sustain, and release phases of the resonance wave to be applied in variable amounts and/or independently of one another. The device of the present invention is particularly suitable for a percussion instrument, such as one that employs a resonating element or membrane, such as drums.

The damper device of the present invention seeks to accomplish mechanically what an audio noise gate accomplishes electronically. A noise gate is an electronic device or software that can be set to automatically mute the signal during parts of the analogue or digital audio signal where the instrument is not being played, and unmute again when the instrument is being played.

The percussion instrument on which the damper device of the present invention may be used includes at least one resonating element or membrane, i.e., drumhead, that is affixed to a hollow drum shell. The drumhead is typically retained within a rim that may be affixed to the drum shell by clamps, lugs or screws.

Generally, the device of the present invention employs a damper pad in combination with a support member, such as one or more flexible, resilient legs, that allow variable amounts of damping depending on the amount of force applied to the attack. When at rest, at least a portion of the damper pad is in contact with the resonating portion of the instrument, i.e., the drumhead, and preferably the bottom of the drumhead. The force applied to the attack of the instrument, e.g., by striking a drumhead with a stick, is transferred to the device of the present invention, which causes the movable support to move such that the damper pad temporarily loses contact with the resonating portion of the instrument. The result is that the instrument will resonate freely for an amount of time before the resiliency of the support member brings the damper pad back into contact with the instrument's resonating portion.

An embodiment of the present invention is directed to a damper device comprising one or more support members, a damper pad, and optionally an attachment member for connecting the support member to the instrument. In a further embodiment, the support member or attachment member is configured to allow movement of the damper pad between a user determined resting position or deflected position, giving the user the option to disengage the damper pad from the drumhead for undamped play.

Another embodiment of the present invention is directed to a percussion instrument comprising a drumhead, i.e., resonating membrane, and a drum shell, wherein the damper device described herein is mounted to the drum shell and the damper pad contacts the drumhead in the resting position and does not contact the drumhead in the deflected position.

A further embodiment of the present invention is directed to a method of variably damping a percussion instrument comprising a drumhead and a drum with the damper device described herein. The method comprises the steps of mounting the damper device to the drum whereby the damper pad contacts the drumhead in a resting position, i.e., in contact with the drumhead, and applying a striking force to the drumhead such that the damper pad moves from the resting position to the deflected position, i.e., no longer in contact with the drumhead, and then returns to the resting position.

These and other features and advantages of the present invention will become more readily appreciated in reference to the following detailed description when considered in connection with the accompanying drawings.

### BRIEF DESCRIPTION OF THE DRAWINGS

FIG. 1 shows a front view of an embodiment of the support member of the damper device of the present invention.

FIG. 2 shows a perspective view of an embodiment of the damper pad of the damper device of the present invention.

FIG. 3 shows a perspective view of an embodiment of the damper device of the present invention.

FIG. 4 shows a perspective of an embodiment of the damper device of the present invention with the legs in a flexed position.

FIG. 5 shows a bottom perspective view of an embodiment of the damper device of the present invention mounted inside a drum.

FIG. 6 shows a side perspective view of an embodiment of the damper device of the present invention mounted inside a drum.

FIG. 7 shows a side perspective view of an embodiment of the damper device of the present invention mounted inside a simplified depiction of a drum in a resting position.

FIG. 8 shows a side perspective side view of an embodiment of the damper device of the present invention mounted inside a simplified depiction of a drum in a deflected position when a force is applied to the drumhead.

FIG. 9 shows a side view of an embodiment of the damper device of the present invention mounted inside a simplified depiction of a drum in a resting position.

FIG. 10 shows a side view of an embodiment of the damper device of the present invention mounted inside a simplified depiction of a drum in a deflected position when a force is applied to the drumhead.

FIG. 11 shows a side view of an embodiment of the damper device of the present invention mounted inside a simplified depiction of a drum in a returning position after a force has been applied to the drumhead.

FIG. 12 shows a perspective view of an alternative embodiment of the damper device of the present invention where the support member comprises rigid legs movable about a spring-biased hinge.

FIG. 13 shows a perspective view of a further alternative embodiment of the damper device of the present invention where the support member comprises rigid legs movable about a spring-biased elbow.

FIG. 14 shows a front view of an embodiment of the support member of the damper device of the present invention comprising legs with an attachment member comprising ring terminals for mounting the device with screws.

FIG. 15 shows a perspective view of an embodiment of the damper pad of the damper device of the present invention with an optional damper cloth affixed to the damper pad.

FIG. 16 shows various embodiments of the shape of the damper pad of the damper device of the present invention.

FIG. 17 shows a front cross-sectional view of an embodiment of the support member of the damper device of the present invention comprising legs with an optional insulation coating.

FIG. 18 shows a top view of an alternative embodiment of the damper device of the present invention employing a support member comprising six legs.

FIG. 19 shows a side perspective view of an alternative embodiment of the damper device of the present invention where the support member comprises a single leg.

### DETAILED DESCRIPTION OF THE PREFERRED EMBODIMENT

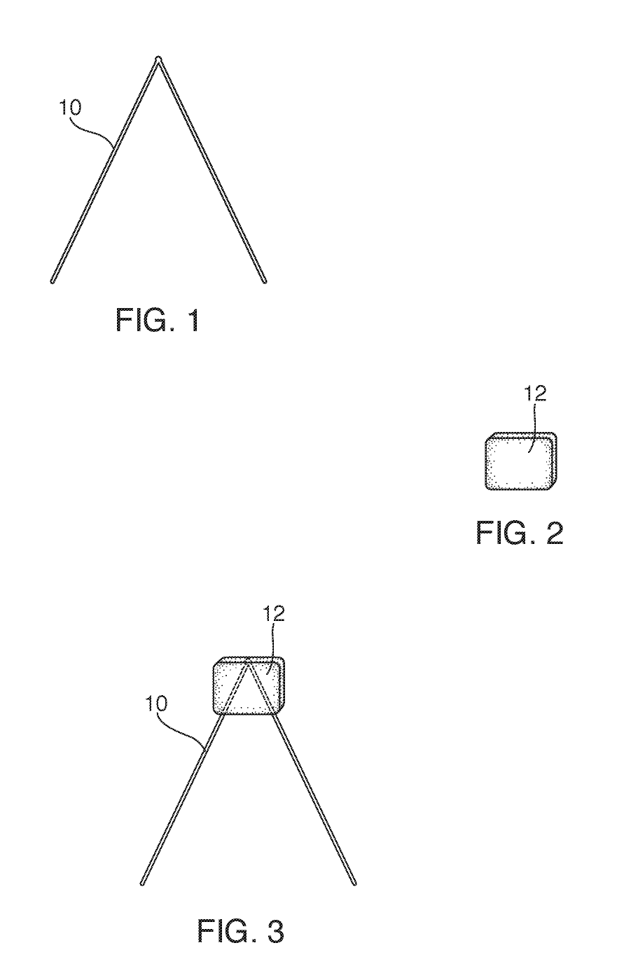

Referring to the figures, wherein like numerals indicate like or corresponding parts throughout the several views, the damper device of the present invention employs a damper pad 12 shown in FIG. 1. The damper pad 12 can be made out of any material that does not readily conduct sound waves and is preferably made out of foams, felts, natural fibers, synthetic fibers, silicones, polyurethanes, waxes, and combinations thereof. The damper pad 12 is used to dampen the resonance of the musical instrument by absorbing the vibrations that it receives. The damper pad 12 can be made in any shape, examples of which are shown in FIG. 16, and is preferably a square, rectangle, circle, or oval. In an embodiment, the damper pad 12 is the same shape of the resonating piece of the instrument, i.e., a circular damper pad for a circular drum.

To increase the performance and lower the acoustic sound caused by friction between the damper pad 12 and the drumhead 16, a damper cloth 32 may be adhered to the damper pad 12, as shown in FIG. 15. The damper cloth 32 is preferably made from a natural or synthetic fiber, and is most preferably made from cotton.

The damper device of the present Invention also employs one or more support members, preferably in the form of legs 10, as shown in FIG. 1. In a preferred embodiment, the legs 10 are made of a resilient, flexible material capable of deforming and returning to its original shape, such as plastic ribbon, elastic ribbon, or metal wire. in a preferred embodiment, the legs 10 are made of a resilient metal wire or strip.

Of course, the legs 10 may be rigid with one or more elements for moving the damper pad 12 into and out of engagement with the drumhead, either as part of the legs 10, part of the attachment member 14, or as part of an intermediate component. Some examples of such embodiments are described below, without limitation.

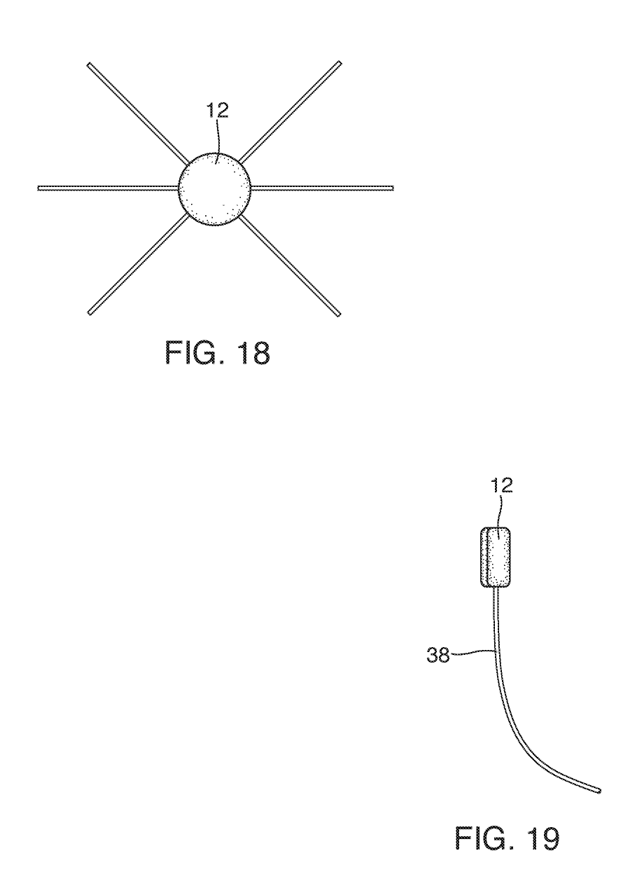

The preferred number of legs 10 in an embodiment of the invention is two, as shown in FIG. 3, but additional legs can be added or fewer can be used in order to lessen or increase the damping pressure, as desired. FIG. 18 shows an embodiment of a damper device with six legs 10. Additional legs 10 may be used where the application of increased pressure on the damper pad 12 is desired, such as for a large instrument like a bass drum. Multiple legs may be individually formed or formed by bending a single leg piece into two or more sections, with each section being a leg 10 described herein.

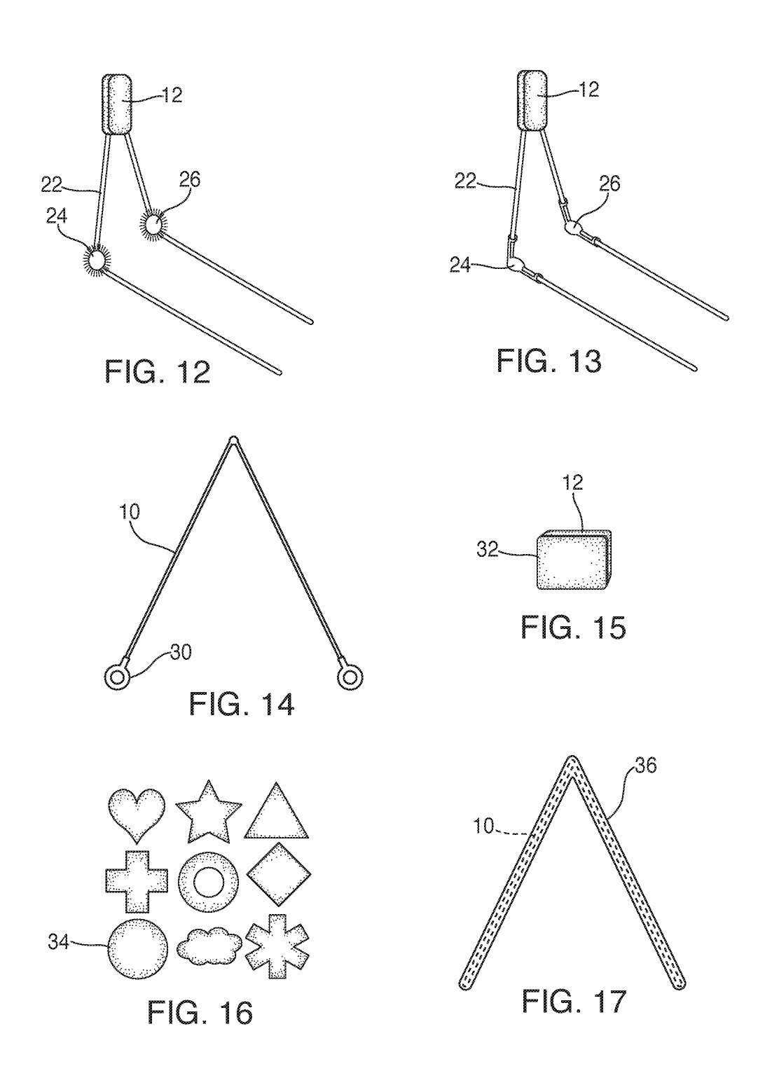

In another embodiment, as shown in FIG. 12, the support member 10 comprises legs 10′ made from a rigid material and constructed from two or more separate pieces that are joined by a moveable elbow 26, i.e., hinge, that is biased by a spring 24. The spring 24 biases the elbow 26 toward maintaining the components of the legs 22 in an approximately straight line. In a further embodiment, shown in FIG. 13, the legs 22 are made from a rigid material and are constructed from two or more separate pieces that are joined by a resilient, elastic elbow 28 that biases the elbow 28 toward maintaining the components of the legs 22 in an approximately straight line. The rigid material of the legs 22 may be metal, wood, or plastic. The spring 24 and elastic elbow 28 may be a compression spring, tension spring, torsion spring, coil spring, leaf spring, strip of resilient material or other type spring that biases the components of the legs 22 as described above.

Under extreme conditions, a striking force applied to a drumhead 16 may cause the legs 10/22 to vibrate and make an audible sound. To prevent this, in an embodiment of the present invention the legs 10/22 can be coated or wrapped with a sound-insulating coating 36, as shown in FIG. 17. The sound-insulating coating is preferably a foam, rubber, plastic, silicone or other elastomeric material known in the art

FIG. 3 shows an embodiment of the damper device of the present invention with the damper pad 12 connected to the legs 10. In a preferred embodiment, the legs 10/22 may be connected to the damper pad 12 by inserting them through the interior of the damper pad 12, such that the legs 10/22 are retained therein. Inserting the legs 10/22 at an angle relative to a side edge of the damper pad 12 or relative to each other will aid in retaining the damper pad 12 in place flush against the bottom surface of the drumhead when in a resting position. For example, the legs 10/22 may be inserted at an angle of about 10-80°, preferably about 30-60° , and most preferably about 45° relative to a side edge of the damper pad 12 or relative to one another. In another embodiment, the legs 10/22 are connected to the damper pad 12 by any suitable elements, including but not limited to adhesives, tapes, staples, clasps, clips, pins, clasps, stitching, weaving, and combinations thereof.

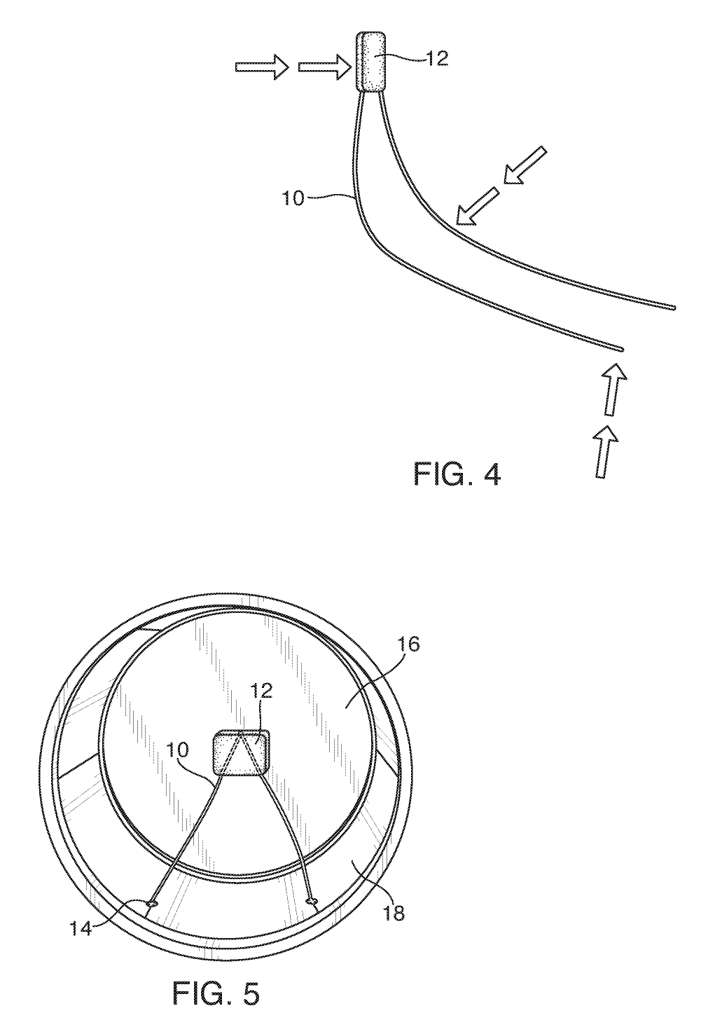

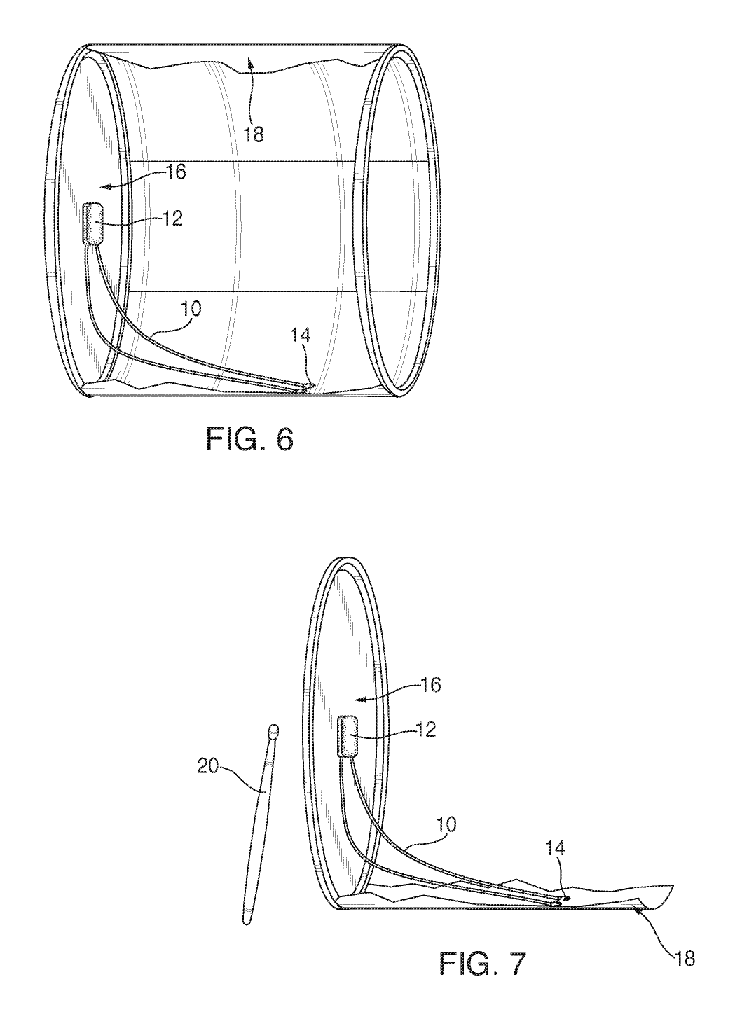

Shown in FIG. 4, the legs 10/22 are preferably resilient and approximately straight while at rest, but are able to bend to a flexed or curved configuration when a force is applied and subsequently return to the straight configuration when the force is removed. In a preferred embodiment, the damper device of the present invention also includes an attachment member or connection component. The connection component 14 may be part of, or connected to, the legs 10/22 or applied to the legs 10/22 when the damper device is mounted. In a preferred embodiment, the connection component is one or more screws 14 as shown in FIGS. 5-6. The screws 14 may be used with ring terminals 30, as shown in FIG. 14, that may be attached to the ends of the legs 10/22 opposite the damper pad 12. In another embodiment, the connection component may be any known element, including but not limited to adhesives, tapes, clamps, clasps, clips, pins, snaps, hook and loop fasteners, magnets, and combinations thereof.

In an embodiment, the damper pad 12 is connected to first portions of the legs 10/22 and the connection component is connected to second portions of the legs 10/22. In embodiments where the legs 10 are made from a single ribbon or wire of resilient material, the first and second portions are merely the first and second ends of the ribbon or wire. In embodiments where the legs 22 are made from a separate pieces of a rigid material joined by a hinge and/or spring, the first and second portions refer to the separate components of the legs 22.

As shown in FIGS. 5-11, the damper device is preferably mounted within a percussion instrument having one or more drumheads 16 having inner and outer surfaces that are affixed to a hollow drum shell 18 having inner and outer surfaces. The damper device may be mounted using the connection component to the inner or outer surface of the drum 18 or to any hardware located on the inner or outer surface of the drum shell 18, such as mounts, arms, tension rods, lugs, screws, rings, hooks, and the like. In types of drums wherein the drumhead 16 is retained within a rim, the connection component may be mounted to the rim by any known member or means, including a friction fit within the rim.

The connection component is mounted to the drum shell 18 or related part such that the damper pad 12 contacts the drumhead 16. In a preferred embodiment, substantially an entire surface of the damper pad 12 is in contact with the drumhead 16. In a preferred embodiment, when the damper device is mounted to the inner surface of the drum shell 18 or related portion thereof, the damper pad 12 will contact the inner surface of the drumhead 16. Conversely, when the damper device is mounted to the outer surface of the drum shell 18 or related portion thereof, the damper pad 12 will contact the outer surface of the drumhead 16.

The damper device is preferably mounted to the drum shell 18 or related component such that the legs 10/22 are flexed, i.e., curved, as shown in FIGS. 6, 7, and 9, when the damper pad 12 is contacting the drumhead 16 in the resting position, which will help ensure that the damper pad 12 does not sway or bounce off axis. Thus, when the legs 10/22 are in a straight configuration, the distance between the connection component and the surface of the damper pad 12 that will contact the drumhead 16 should be greater than the distance between the connection component and the drumhead 16 when the damper device is mounted in a drum 18.

Shown in FIG. 7, when no striking force is applied to the instrument, the legs 10/22 bias the damper pad 12 into contact with the drumhead 16, i.e., the resting position. This helps to prevent or reduce undesirable low level vibrations from causing the drumhead 16 to resonate, and is identified as the resting position because the drumhead 16 is not resonating and makes no sound. The resting position can also be seen in FIG. 9.

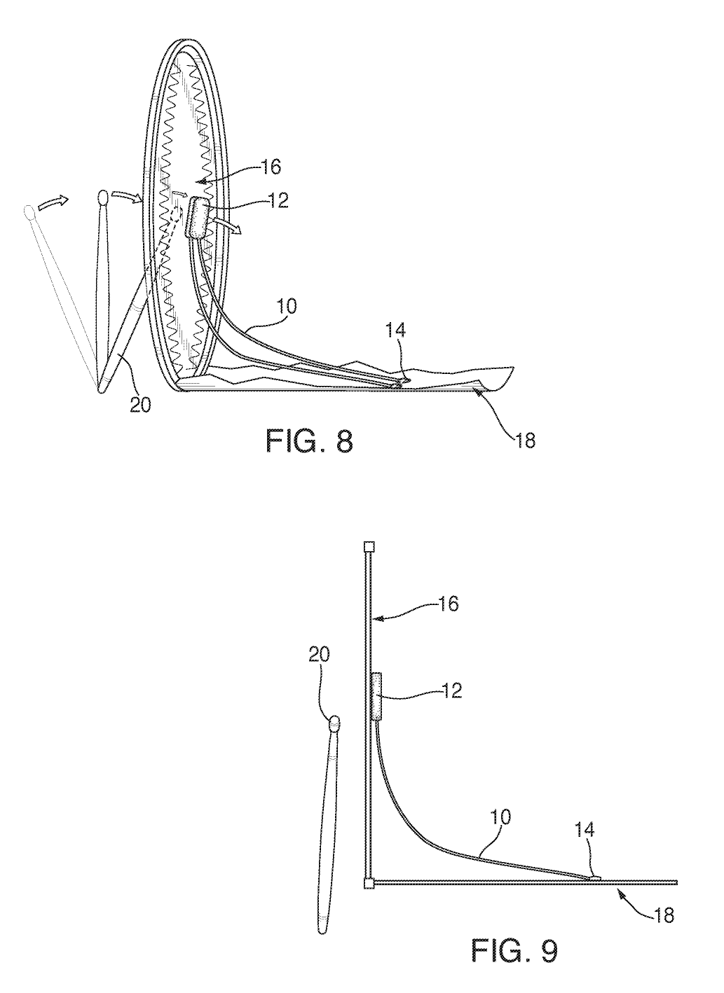

Various objects can be used to apply the striking force to the drumhead 16. FIG. 8 depicts a drumstick 20 as an example to help explain the results, however, it should be understood that other objects such as mallets, hands, arms, beaters, and other tools are also contemplated by the present invention.

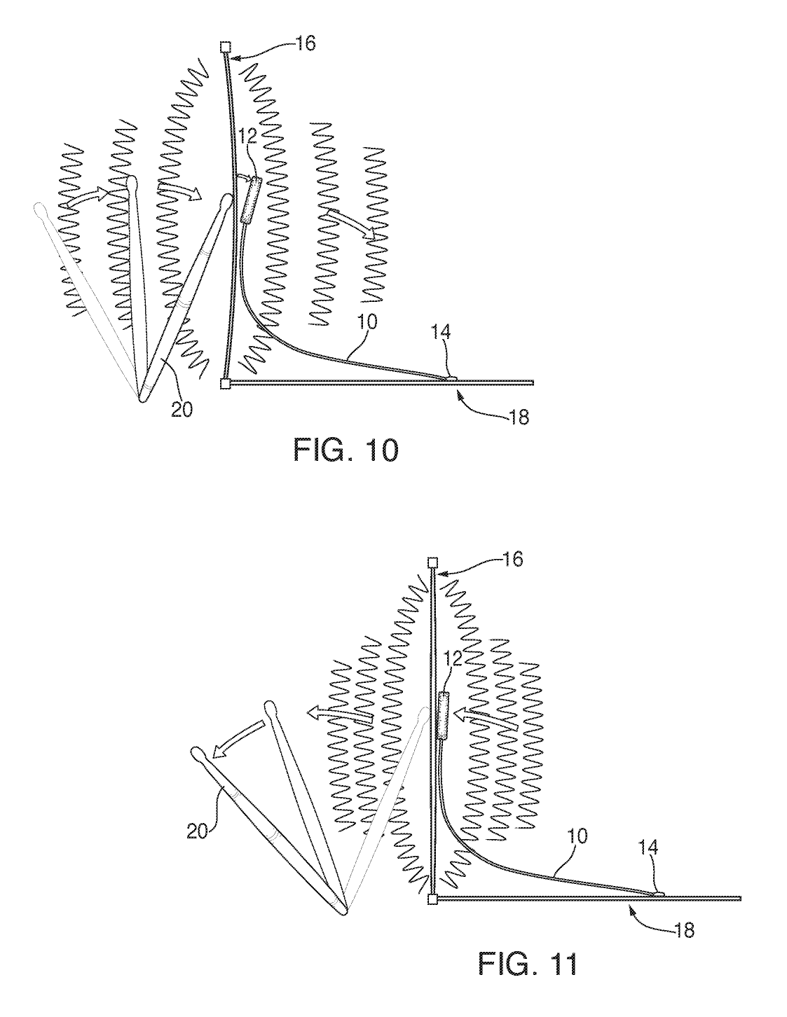

Applying a striking force to the drumhead 16 sets off a series of events. First, the force from the strike is transferred to the drumhead 16 and then is transferred to the damper pad 12 in contact with the drumhead 16. The striking force from the attack of the drumstick 20 is greater than, and therefore overcomes, the force applied by the legs 10/22 that holds the damper pad 12 in contact with the drumhead 16. This causes the damper pad 12 to move away from the drumhead 16 into a deflected position whereby there is no contact between the damper pad 12 and drumhead 16. Thus, the damper pad 12 having no contact with the drumhead 16 allows the drumhead 16 to resonate from the force applied by the drumstick 20. As shown in FIG. 10, the damper pad 12 is not in contact with the drumhead 16 which is resonating freely.

FIG. 11 shows that after sufficient time has passed, such as from .01-1000 milliseconds, and the striking force from the drumstick 20 that moved the damper pad 12 into the deflected position becomes absorbed, the resiliency of the legs 10/22 returns the damper pad 12 back into contact with the drumhead 16 in the resting position, damping the resonance to a halt. The damper device of the present invention thus enables the percussion instrument to have a loud freely resonate attack, a short decay, a damped sustain, and damped release. The length of the decay is proportional to the amount of tension the legs 10/22 apply. Thus, the decay can be lengthened by reducing the tension of the legs 10/22 and can be shortened by increasing the tension of the legs 10/22.

The present invention is also directed to a method of variably damping a percussion instrument comprising a drumhead 16 and a drum shell 18 using the damper device of the present invention. The method includes the step of mounting the damper device to the drum shell 18, including one or more related components, whereby the damper pad 12 contacts the drumhead 16 in the resting position, and the legs 10/22 are in a flexed configuration. The method further includes the step of applying a striking force to the drumhead 16, such as by a drumstick 20, such that the damper pad 12 moves to the deflected position and is not contacting the drumhead 16, and then subsequently returns to the resting position due to the resiliency of the legs 10/22 in contact with the drumhead 16.

The striking force produces a resonance wave having an attack phase, a decay phase, a sustain phase, and a release phase. In an embodiment of the present invention, the damper pad 12 is in deflected position not in contact with the drumhead 16 during the attack phase, and in the resting position in contact with the drumhead 16 prior to the striking force and during the decay phase, the sustain phase, and the release phase. In another embodiment of the present invention the damper pad 12 is in deflected position not in contact with the drumhead 16 during the attack phase and decay phase, and in the resting position in contact with the drumhead 16 prior to the striking force and during the sustain phase, and the release phase.

Although the invention is described herein for use with drums, it should be understood that the damper device of the present invention may be used with other instruments, including pianos, guitars, banjos, violins, harps, xylophones, cymbals, bells, and glockenspiels.

The invention described herein may be practiced in the absence of any element or elements, limitation or limitations which is not specifically disclosed herein. Thus, for example, in each instance herein, any of the terms “comprising,” “consisting essentially of” and “consisting of” may be replaced with either of the other two terms.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present Invention has been specifically disclosed by preferred embodiments and optional features, modification and variation of the concepts herein disclosed may be resorted to by those skilled in the art, and that such modifications and variations are considered to be within the scope of this invention as defined by the claims.

1. A damper device comprising a damper pad and one or more support members wherein the one or more support members permit the damper pad to move between a resting position and a deflected position.

2. The damper device of claim 1 wherein the damper device further comprises a connection component that is formed by, or connected to, the one or more support members.

3. The damper device of claim 2 wherein the connection component is selected from the group consisting of rings, screws, adhesives, clamps, clips, pins, clasps, hook and loop fasteners, and magnets.

4. The damper device of claim 1 comprising two support members.

5. The damper device of claim 1 wherein the deflected position occurs in response to a striking force being transferred to the damper pad of the damper device.

6. The damper device of claim 1 wherein at least one of the one or more support members comprise a resilient material.

7. The damper device of claim 1 wherein at least one of the one or more support members comprise a hinge biased by a spring.

8. The damper device of claim 7 wherein the spring is a compression spring, tension spring, torsion spring, coil spring, leaf spring, or strip of resilient material.

9. The damper device of claim 1 wherein the one or more support members comprise an elastic elbow.

10. The damper device of claim 9 wherein the elastic elbow is a compression spring, tension spring, torsion spring, coil spring, leaf spring or strip of resilient material.

11. A percussion instrument comprising a drumhead and a drum, wherein the damper device of claim 1 is mounted to the drum and the damper pad contacts the drumhead in the resting position.

12. The percussion instrument of claim 11 wherein the damper pad does not contact the drumhead in the deflected position.

13. The percussion instrument of claim 12 wherein the deflected position occurs in response to a striking force applied to the drumhead.

14. The percussion instrument of claim 11 wherein the drum comprises in inner surface and outer surface and the drumhead comprises an inner surface and outer surface, and wherein the damper device is mounted to the inner surface of the drum and the damper pad contacts the inner surface of the drumhead in the resting position.

15. The percussion instrument of claim 14 wherein the damper pad does not contact the drumhead in the deflected position.

16. The percussion instrument of claim 15 wherein the deflected position occurs in response to a striking force applied to the drumhead.

17. A method of variably damping a percussion instrument comprising a drumhead and a drum with a damper device comprising one or more support members and a damper pad, wherein the one or more support members are configured to move the damper pad between a resting position and a deflected position, the method comprising the steps of:
mounting the damper device to the drum whereby the damper pad contacts the drumhead in the resting position, and
applying a striking force to the drumhead such that the damper pad moves to the deflected position whereby the damper pad is not in contact with the drumhead, and then returns to the resting position whereby the damper pad contacts the drumhead.

18. The method of claim 17 wherein the striking force produces a resonance wave having an attack phase, a decay phase, a sustain phase, and a release phase, and wherein the deflected position of the damper pad occurs during the attack phase of the resonance wave.

19. The method of claim 17 wherein the striking force produces a resonance wave having an attack phase, a decay phase, a sustain phase, and a release phase, and wherein the deflected position of the damper pad occurs during the attack phase and decay phase of the resonance wave.
